(19) United States
(12) Patent Application Publication
(10) Pub. No.: US 2015/0034129 A1
(43) Pub. Date: Feb. 5, 2015

(54) DEWAXING DEVICE AND METHOD OF DEWAXING USING THE DEWAXING DEVICE

(71) Applicant: Cheng Uei Precision Industry Co., Ltd., New Taipei City (TW)

(72) Inventors: CHENG YU CHOU, New Taipei City (TW); CHEN LUEN TSAI, New Taipei City (TW); CHE WEI HSU, New Taipei City (TW); CHIH WEI CHENG, New Taipei City (TW)

(73) Assignee: Cheng Uei Precision Industry Co., Ltd., New Taipei City (TW)

(21) Appl. No.: 13/959,726

(22) Filed: Aug. 5, 2013

(51) Int. Cl. B08B 3/08; B08B 3/10

(52) U.S. Cl. CPC B08B 3/08; B08B 3/106
USPC 134/26; 134/95.1

(57) ABSTRACT

A dewaxing device and a method of dewaxing using the dewaxing device are shown. The dewaxing device includes a dewaxing system including a rinsing device and a storage device, and a recycling system connected with the storage device. The storage device includes a first solvent trough and a second solvent trough of which each is connected with the rinsing device and is equipped with a heating equipment. When the first solvent trough is connected with the rinsing device, the second solvent trough is disconnected with the rinsing device; when the second solvent trough is connected with the rinsing device, the first solvent trough is disconnected with the rinsing device. So, the dewaxing device can provide two dewaxing processes and effectively reduce recycling frequency because the recycling process is done after soluble wax quantity of bromopropane solvent reaches the maximum value 16%. The production cost is accordingly reduced.

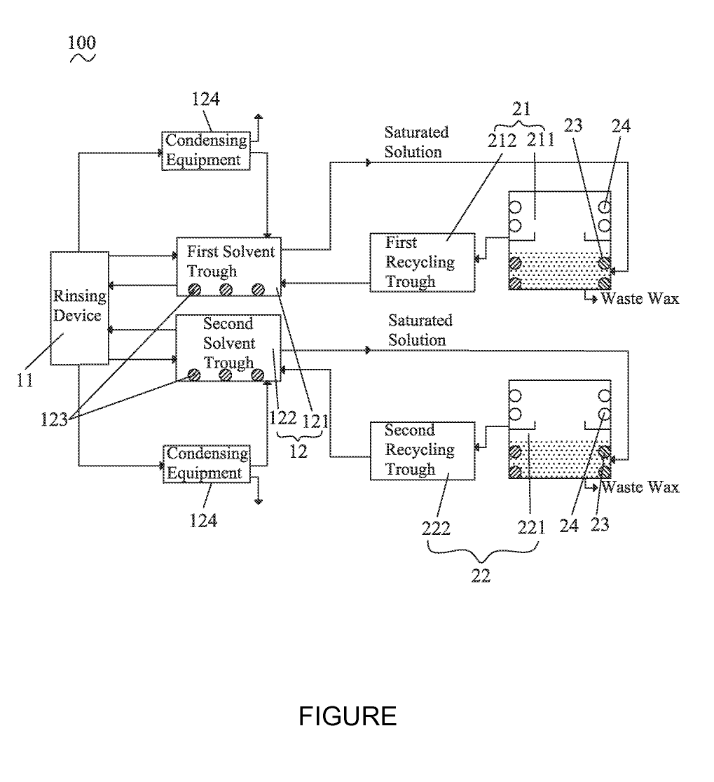

### BACKGROUND OF THE INVENTION

1. Field of the Invention

The present invention relates to a dewaxing device, and more particularly to a chemical dewaxing device and a method of dewaxing using the chemical dewaxing device.

2. The Related Art

Metal injection molding is a metalworking process where finely-powdered metal is mixed with a measured amount of binder and wetting agent to comprise a feedstock capable of being handled by plastic processing equipment through a process known as injection mold forming. Subsequent conditioning operations are performed on the molded shape, where the wetting agent and the binder are removed from a green part of product and metal particles are coalesced into the desired state for the metal alloy. In detail, the wetting agent is removed by chemical solvent or sintering furnace to form pores in dewaxing process of the metal injection molding, and the binder is thermal-cracked into binder gas to go out through the pores in sintering process of the metal injection molding.

In order to effectively achieve the dewaxing process, it is a common way that the wetting agent is removed by the chemical solvent. In detail, the wetting agent can be removed by repeatedly rinsing the green part of product with the chemical solvent or keeping soaking the green part of product in the chemical solvent so as to dissolve the wetting agent out of the green part of product, wherein the chemical solvent can be n-hexane, n-butane, bromopropane, cleaning naphtha and so on. Because of increased awareness of environmental protection, the chemical solvent has gradually tended to use the bromopropane solvent which has recyclable and atmospheric cracking characteristics. In the process of recycling, the bromopropane solvent needs to be heated to boiling and then be cooled so that will have a strong impact on use life of the bromopropane solvent.

In order to prolong use life of the bromopropane solvent, generally try to improve the soluble wax quantity of the bromopropane solvent so as to reduce the recycling frequency. Therefore, in the process of dewaxing the green part of product, the bromopropane solvent is often heated so as to improve the soluble wax quantity thereof. But the product needs to be cooled to room temperature before it is taken out from a dewaxing device, so as to avoid the product cracking on account of thermal shock. So at the end of the dewaxing process, the bromopropane solvent needs to be gradually cooled to room temperature, and then circulates through the product to gradually cool the product to the room temperature. However, the different temperatures have a great impact on the soluble wax quantity of the bromopropane solvent.

For example, the soluble wax quantity of the bromopropane solvent can reach a maximum value of 16% at 45 degrees Celsius, but once back to the room temperature, the soluble wax quantity of the bromopropane solvent will plummet to 3%. Assume that the soluble wax quantity of the bromopropane solvent has been up to 2.9%, after using the bromopropane solvent of 45 degrees Celsius to carry out the dewaxing process, the soluble wax quantity of the bromopropane solvent reaches 3.5%. When the temperature of the bromopropane solvent gradually drops to cool the product to the room temperature, because the highest soluble wax quantity of the bromopropane solvent is 3% at the room temperature, extra 0.5% of dissolved wax will become solid to adhere on outside surfaces of the product so that often seals up the pores formed in the dewaxing process. As a result, the binder gas thermal-cracked in the subsequent sintering process is stuck in the product to finally bring the product about severe deformation, bad appearance of bubble, burst or collapse etc. Therefore, in order to avoid extra wax adhering on the outside surfaces of the product, the soluble wax quantity of the bromopropane solvent is often set less than 2% so as to stabilize production. However, as a result, the recycling is frequent and the production cost is high.

### SUMMARY OF THE INVENTION

An object of the present invention is to provide a dewaxing device of utilizing chemical solvent to dewax a green part of product formed by metal injection molding. The dewaxing device includes a dewaxing system and a recycling system. The dewaxing system includes a rinsing device where the green part of product is placed and a storage device where the chemical solvent is stored. The storage device includes a first solvent trough and a second solvent trough of which each is connected with the rinsing device via a circulation pipe to make the chemical solvent circulation flow through the rinsing device to repeatedly rinse the green part of product. Each of the first solvent trough and the second solvent trough is equipped with a heating equipment for heating the chemical solvent. The recycling system includes a first recycling device and a second recycling device which are connected with the first solvent trough and the second solvent trough respectively for treating mixed solution with wax into pure chemical solvent. When the first solvent trough is connected with the rinsing device, the second solvent trough is disconnected with the rinsing device; when the second solvent trough is connected with the rinsing device, the first solvent trough is disconnected with the rinsing device.

Another object of the present invention is to provide a method of using the dewaxing device to dewax the green part of product. The method includes the following steps:
(1) utilize the heating equipments to heat the bromopropane solvent in the first solvent trough and the second solvent trough to 45 degrees Celsius and 40˜45 degrees Celsius respectively;
(2) connect the first solvent trough with the rinsing device and disconnect the second solvent trough with the rinsing device, convey the bromopropane solvent of 45 degrees Celsius from the first solvent trough into the rinsing device and further flow the bromopropane solvent between the first solvent trough and the rinsing device in a circulatory way to do a first dewaxing process by soaking and repeatedly rinsing the green part of product;
(3) convey all of the bromopropane solvent with wax of 45 degrees Celsius from the rinsing device into the first solvent trough after the first dewaxing process is finished, then disconnect the first solvent trough with the rinsing device and connect the second solvent trough with the rinsing device;
(4) convey the bromopropane solvent of 40˜45 degrees Celsius from the second solvent trough into the rinsing device and then turn off the heating equipment in the second solvent trough to gradually drop the temperature of the bromopropane solvent, the bromopropane solvent flow between the second solvent trough and the rinsing device in a circulatory way to do a second dewaxing process and simultaneously gradually cool the green part of product to the room temperature;
(5) take the green part of product with the wax being removed out of the rinsing device, and place next green part of product in the rinsing device to carry out the steps (1)˜(4), until the bromopropane solvent in the first solvent trough is monitored to reach saturation state, the saturated mixed bromopropane solution is conveyed into the first containing trough and heated to boiling by the heating unit to separate into bromopropane steam and high concentration of non-volatile liquid waste wax;
(6) utilize the condensing unit to condense the bromopropane steam into liquid to flow into the first recycling trough, pure bromopropane solvent is obtained in the first recycling trough and conveyed back into the first solvent trough to be reused, the high concentration of non-volatile liquid waste wax is removed out of the first containing trough;
(7) utilize the heating equipments to heat the pure bromopropane solvent and the mixed bromopropane solution in the first solvent trough and the second solvent trough to 40˜45 degrees Celsius and 45 degrees Celsius respectively, connect the second solvent trough with the rinsing device and disconnect the first solvent trough with the rinsing device;
(8) utilize the mixed bromopropane solution in the second solvent trough to carry out the first dewaxing process, then disconnect the second solvent trough with the rinsing device and connect the first solvent trough with the rinsing device to utilize the recycled pure bromopropane solvent in the first solvent trough to carry out the second dewaxing process, until the bromopropane solvent in the second solvent trough is monitored to reach saturation state, the recycling process is done by the recycling system; and
(9) repeat the steps (1)˜(8).

As described above, the dewaxing device in this invention utilizes the cooperation design of the first solvent trough and the second solvent trough to thoroughly dewax the green part of product through two dewaxing processes. Furthermore, the dewaxing device can effectively reduce the recycling frequency because the recycling process is done after the soluble wax quantity of the bromopropane solvent reaches the maximum value 16%, compared to the maximum soluble wax quantity of 2% in the prior art. The production cost is accordingly reduced.

### BRIEF DESCRIPTION OF THE DRAWINGS

The present invention will be apparent to those skilled in the art by reading the following description, with reference to the attached drawing, in which:

The FIGURE is a view of a dewaxing device according to an embodiment of the present invention.

### DETAILED DESCRIPTION OF THE PREFERRED EMBODIMENT

With reference to the FIGURE, a dewaxing device 100 according to an embodiment of the present invention is used in dewaxing process of metal injection molding for removing wax of a green part of product by virtue of utilizing chemical solvent to soak and repeatedly rinse the green part of product. In this embodiment, the chemical solvent is bromopropane solvent. The dewaxing device 100 includes a dewaxing system and a recycling system.

The dewaxing system includes a rinsing device 11 where the green part of product is placed for being soaked and rinsed with the bromopropane solvent, and a storage device 12 where the bromopropane solvent is stored. The storage device 12 includes a first solvent trough 121 and a second solvent trough 122 of which each is connected with the rinsing device 11 via a circulation pipe so that the bromopropane solvent can circulation flow through the rinsing device 11 to repeatedly rinse the green part of product so as to dissolve the wax out of the green part of product as thorough as possible. Each of the first solvent trough 121 and the second solvent trough 122 is equipped with a heating equipment 123 which is used to heat the bromopropane solvent so as to improve dewaxing efficiency. Between the rinsing device 11 and each of the first solvent trough 121 and the second solvent trough 122 a condensing equipment 124 is connected via a pipe. Because bromopropane is highly volatile, the condensing equipments 124 are used to condense volatilized bromopropane steam in the dewaxing process into liquid bromopropane solvent and further make the condensed bromopropane solvent flow back into the first solvent trough 121 and the second solvent trough 122 of the storage device 12.

The recycling system includes a first recycling device 21 and a second recycling device 22 which are connected with the first solvent trough 121 and the second solvent trough 122 respectively for treating mixed solution with wax into pure chemical solvent. In detail, the first recycling device 21 includes a first containing trough 211 connected with the first solvent trough 121 via a pipe, and a first recycling trough 212 connected between the first containing trough 211 and the first solvent trough 121 via a pipe. The second recycling device 22 includes a second containing trough 221 connected with the second solvent trough 122 via a pipe, and a second recycling trough 222 connected between the second containing trough 221 and the second solvent trough 122 via a pipe. The first containing trough 211 and the second containing trough 221 are used to contain mixed bromopropane solution with wax from the first solvent trough 121 and the second solvent trough 122 respectively and further treat the mixed bromopropane solution into pure bromopropane solvent. The first recycling trough 212 and the second recycling trough 222 are used to contain the pure bromopropane solvent from the first containing trough 211 and the second containing trough 221 and further convey the pure bromopropane solvent back into the first solvent trough 121 and the second solvent trough 122 to be reused. Each of the first containing trough 211 and the second containing trough 221 is equipped with a heating unit 23 and a condensing unit 24. In use, when the bromopropane solvent in the first solvent trough 121 reaches saturation state, the saturated solution is conveyed into the first containing trough 211 and then is heated by the heating unit 23 to separate into bromopropane steam and high concentration of non-volatile liquid waste wax. The liquid waste wax is removed, and the bromopropane steam is condensed by the condensing unit 24 into liquid to flow into the first recycling trough 212 and the second recycling trough 222 so as to obtain the pure bromopropane solvent, then the pure bromopropane solvent is conveyed back into the first solvent trough 121 and the second solvent trough 122 to be reused.

In this embodiment, the green part of product is placed in the rinsing device 11. When the first solvent trough 121 is connected with the rinsing device 11, the second solvent trough 122 is disconnected with the rinsing device 11. On the contrary, when the second solvent trough 122 is connected with the rinsing device 11, the first solvent trough 121 is disconnected with the rinsing device 11.

Referring to the FIGURE again, a method of using the above-mentioned dewaxing device 100 to dewax the green part of product formed by metal injection molding is described as follows.

Firstly, contain the bromopropane solvent in the storage device 12 and utilize the heating equipments 123 to heat the bromopropane solvent in the first solvent trough 121 and the second solvent trough 122 to 45 degrees Celsius and 40˜45 degrees Celsius respectively. The first solvent trough 121 is connected with the rinsing device 11 and the second solvent trough 122 is disconnected with the rinsing device 11.

Then, convey the bromopropane solvent of 45 degrees Celsius from the first solvent trough 121 into the rinsing device 11 to do a first dewaxing process for the green part of product by soaking and rinsing. In the first dewaxing process, the bromopropane solvent flows between the first solvent trough 121 and the rinsing device 11 in a circulatory way so as to reduce wax concentration around the green part of product and ensure the green part of product to be dewaxed efficiently. The heating equipment 123 in the first solvent trough 121 continuously works to keep the bromopropane solvent at 45 degrees Celsius so as to furthest dewax the green part of product at maximum soluble wax quantity of 16%. After the first dewaxing process is finished, the bromopropane solvent becomes a mixed bromopropane solution with wax without lowing temperature. Then directly convey all of the mixed bromopropane solution of 45 degrees Celsius from the rinsing device 11 into the first solvent trough 121. After there is no solution in the rinsing device 11, disconnect the first solvent trough 121 with the rinsing device 11 and connect the second solvent trough 122 with the rinsing device 11.

Next, convey the bromopropane solvent of 40˜45 degrees Celsius from the second solvent trough 122 into the rinsing device 11 to do a second dewaxing process for the green part of product, and the bromopropane solvent flows between the second solvent trough 122 and the rinsing device 11 in a circulatory way too. In the second dewaxing process, turn off the heating equipment 123 in the second solvent trough 122, and control the highest soluble wax quantity of the bromopropane solvent at 2%. During the mixed bromopropane solution of 45 degrees Celsius is replaced with the bromopropane solvent of 40˜45 degrees Celsius in the rinsing device 11, because the green part of product is always remained in the rinsing device 11, there is no thermal shock on the green part of product so that effectively avoids the product cracking and ensures product yield. After turning off the heating equipment 123 in the second solvent trough 122, the temperature of the bromopropane solvent in the second solvent trough 122 gradually drops to gradually cool the green part of product to the room temperature so as to complete the second dewaxing process. Then take the green part of product with the wax being removed out of the rinsing device 11, and place next green part of product in the rinsing device 11 to carry out the above-mentioned steps. Until the bromopropane solvent in the first solvent trough 121 is monitored to reach saturation state, namely the soluble wax quantity in the mixed bromopropane solution reaches the maximum value 16% in this embodiment, the recycling process is done by the recycling system.

In the recycling process, the saturated mixed bromopropane solution in the first solvent trough 121 is conveyed into the first containing trough 211, and is heated to boiling by the heating unit 23 to separate into bromopropane steam and high concentration of non-volatile liquid waste wax. Then utilize the condensing unit 24 to condense the bromopropane steam into liquid to flow into the first recycling trough 212 so that pure bromopropane solvent is obtained and conveyed back into the first solvent trough 121 to be reused. The high concentration of non-volatile liquid waste wax is removed out of the first containing trough 211.

Last, the bromopropane solvent in the first solvent trough 121 is pure to be used for the second dewaxing process, and accordingly, the mixed bromopropane solution in the second solvent trough 122 is used for the first dewaxing process. Utilize the heating equipments 123 to heat the pure bromopropane solvent and the mixed bromopropane solution in the first solvent trough 121 and the second solvent trough 122 to 40˜45 degrees Celsius and 45 degrees Celsius respectively. The second solvent trough 122 is connected with the rinsing device 11 and the first solvent trough 121 is disconnected with the rinsing device 11. Firstly utilize the mixed bromopropane solution in the second solvent trough 122 to carry out the first dewaxing process, then disconnect the second solvent trough 122 with the rinsing device 11, and connect the first solvent trough 121 with the rinsing device 11 to utilize the pure bromopropane solvent to carry out the second dewaxing process. Until the bromopropane solvent in the second solvent trough 122 is monitored to reach saturation state, namely the soluble wax quantity in the mixed bromopropane solution reaches the maximum value 16% in this embodiment, the recycling process is done by the recycling system and so on. Therefore, the dewaxing device 100 can effectively reduce the recycling frequency because the recycling process is done after the soluble wax quantity of the bromopropane solvent reaches the maximum value 16%, compared to the maximum soluble wax quantity of 2% in the prior art. And the production cost is accordingly reduced.

As described above, the dewaxing device 100 in this invention utilizes the cooperation design of the first solvent trough 121 and the second solvent trough 122 to thoroughly dewax the green part of product through two dewaxing processes. Furthermore, the dewaxing device 100 can effectively reduce the recycling frequency because the recycling process is done after the soluble wax quantity of the bromopropane solvent reaches the maximum value 16%, compared to the maximum soluble wax quantity of 2% in the prior art. The production cost is accordingly reduced.

What is claimed is:

1. A dewaxing device of utilizing chemical solvent to dewax a green part of a product formed by metal injection molding, comprising:
a dewaxing system including a rinsing device where the green part of product is placed and a storage device where the chemical solvent is stored, the storage device including a first solvent trough and a second solvent trough of which each is connected with the rinsing device via a circulation pipe to make the chemical solvent circulation flow through the rinsing device to repeatedly rinse the green part of product, each of the first solvent trough and the second solvent trough being equipped with a heating equipment for heating the chemical solvent; and
a recycling system including a first recycling device and a second recycling device which are connected with the first solvent trough and the second solvent trough respectively for treating mixed solution with wax into pure chemical solvent;
wherein when the first solvent trough is connected with the rinsing device, the second solvent trough is disconnected with the rinsing device; when the second solvent trough is connected with the rinsing device, the first solvent trough is disconnected with the rinsing device.

2. The dewaxing device as claimed in claim 1, wherein a condensing equipment is connected between the rinsing device and each of the first solvent trough and the second solvent trough for condensing volatilized chemical steam in the dewaxing process into liquid chemical solvent and further making the liquid chemical solvent flow back into the first solvent trough and the second solvent trough of the storage device.

3. The dewaxing device as claimed in claim 1, wherein the first recycling device includes a first containing trough connected with the first solvent trough for containing mixed solution with wax from the first solvent trough and treating the mixed solution into pure chemical solvent, and a first recycling trough connected between the first containing trough and the first solvent trough for containing the pure chemical solvent from the first containing trough and further conveying the pure chemical solvent back into the first solvent trough to be reused; the second recycling device includes a second containing trough connected with the second solvent trough for containing mixed solution with wax from the second solvent trough and treating the mixed solution into pure chemical solvent, and a second recycling trough connected between the second containing trough and the second solvent trough for containing the pure chemical solvent from the second containing trough and further conveying the pure chemical solvent back into the second solvent trough to be reused.

4. The dewaxing device as claimed in claim 3, wherein each of the first containing trough and the second containing trough is equipped with a heating unit for heating the mixed solution to separate into chemical steam and high concentration of non-volatile liquid waste wax, and a condensing unit for condensing the chemical steam into liquid pure chemical solvent to flow into the first recycling trough and the second recycling trough.

5. The dewaxing device as claimed in claim 1, wherein the chemical solvent is bromopropane solvent.

6. A method of using a dewaxing device to dewax a green part of a product, comprising the steps:
(1) utilizing the heating equipments to heat the bromopropane solvent in the first solvent trough and the second solvent trough to 45 degrees Celsius and 40˜45 degrees Celsius respectively;
(2) connecting the first solvent trough with the rinsing device and disconnecting the second solvent trough with the rinsing device, conveying the bromopropane solvent of 45 degrees Celsius from the first solvent trough into the rinsing device and further flowing the bromopropane solvent between the first solvent trough and the rinsing device in a circulatory way to do a first dewaxing process by soaking and repeatedly rinsing the green part of product;
(3) conveying all of the bromopropane solvent with wax of 45 degrees Celsius from the rinsing device into the first solvent trough after the first dewaxing process is finished, then disconnecting the first solvent trough with the rinsing device and connecting the second solvent trough with the rinsing device;
(4) conveying the bromopropane solvent of 40˜45 degrees Celsius from the second solvent trough into the rinsing device and then turning off the heating equipment in the second solvent trough to gradually drop the temperature of the bromopropane solvent, the bromopropane solvent flowing between the second solvent trough and the rinsing device in a circulatory way to do a second dewaxing process and simultaneously gradually cool the green part of product to the room temperature;
(5) taking the green part of product with the wax being removed out of the rinsing device, and placing next green part of product in the rinsing device to carry out the steps (1)˜(4), until the bromopropane solvent in the first solvent trough is monitored to reach saturation state, the saturated mixed bromopropane solution being conveyed into the first containing trough and heated to boiling by the heating unit to separate into bromopropane steam and high concentration of non-volatile liquid waste wax;
(6) utilizing the condensing unit to condense the bromopropane steam into liquid to flow into the first recycling trough, pure bromopropane solvent being obtained in the first recycling trough and conveyed back into the first solvent trough to be reused, the high concentration of non-volatile liquid waste wax being removed out of the first containing trough;
(7) utilizing the heating equipments to heat the pure bromopropane solvent and the mixed bromopropane solution in the first solvent trough and the second solvent trough to 40˜45 degrees Celsius and 45 degrees Celsius respectively, connecting the second solvent trough with the rinsing device and disconnecting the first solvent trough with the rinsing device;
(8) utilizing the mixed bromopropane solution in the second solvent trough to carry out the first dewaxing process, then disconnecting the second solvent trough with the rinsing device and connecting the first solvent trough with the rinsing device to utilize the recycled pure bromopropane solvent in the first solvent trough to carry out the second dewaxing process, until the bromopropane solvent in the second solvent trough is monitored to reach saturation state, the recycling process being done by the recycling system; and
(9) repeating the steps (1)˜(8).

7. The method as claimed in claim 6, wherein in the first dewaxing process, the corresponding heating equipment continuously works to keep the bromopropane solvent at 45 degrees Celsius to furthest dewax the green part of product at maximum soluble wax quantity of 16%.

8. The method as claimed in claim 6, wherein in the second dewaxing process, the highest soluble wax quantity of the bromopropane solvent is controlled at 2%.
